(19) United States
(12) Patent Application Publication
(10) Pub. No.: US 2017/0041755 A1
(43) Pub. Date: Feb. 9, 2017

(54) USING POSITIONING SIGNALS FROM TRANSMITTERS OF ONE NETWORK TO ESTIMATE POSITIONS OF MOBILE DEVICES OF OTHER NETWORKS

(71) Applicant: NextNav, LLC, Sunnyvale, CA (US)

(72) Inventor: WILLIAM M. SHVODIAN, McLean, VA (US)

(21) Appl. No.: 15/331,127

(22) Filed: Oct. 21, 2016

Related U.S. Application Data
(60) Provisional application No. 62/250,477, filed on Nov. 3, 2015.

(51) Int. Cl. H04W 4/02; H04W 4/22

(52) U.S. Cl. CPC H04W 4/023; H04W 4/22; H04W 84/042

(57) ABSTRACT

Receiving positioning signals in support of estimating positions of receivers. Systems and methods for receiving positioning signals in support of estimating positions of receivers may receive, at a receiver which is authorized to transmit signals through a first network but is not authorized to transmit signals through a second network, positioning signals from transmitters of the second network. The receiver may receive assistance data associated with the second network and further associated with the positioning signals. The positioning signals and the assistance data may be used to generate an estimated position of the receiver.

### TECHNICAL FIELD

This disclosure relates to using positioning signals transmitted from one network in support of estimating positions of receivers of other networks.

### BACKGROUND

The U.S. Federal Communications Commission (FCC) requires wireless carrier networks (“operators”) to determine and transmit the location of callers who dial 911 from their mobile devices (“receivers”). One way of determining the location of a receiver uses signals from orbiting satellites. However, determining the location of a receiver in regions that have poor satellite signal quality, such as outdoor urban environments or indoor environments, can be quite challenging. One alternative way of determining the location of a receiver in regions that have poor satellite signal quality uses terrestrial transmitters that transmit positioning signals in licensed spectrums. One such positioning signal is an Observed Time Difference of Arrival (OTDOA) Positioning Reference Signal (PRS). When using terrestrial transmitters to transmit positioning signals, operators must typically allocate a portion of their spectrum for transmission of such positioning signals to receivers and for receiving related signaling from a receiver, but the allocated spectrum cannot be used for exchanging other signals that generate income (e.g. voice and data signals). In some cases, operators can lose up to 4% of their licensed spectrum by transmitting positioning signals. For operators with a spectrum capacity that is worth millions or billions of dollars, allocating 4% of that spectrum to what may be a non-revenue generating task like positioning is not desirable. Given that spectrum is a valuable asset to operators, it is in their best interest to use it as efficiently as possible. Thus, approaches are needed so positions of receivers can be determined while operators maximize revenue-generating use of their spectrum.

### BRIEF DESCRIPTION OF THE DRAWINGS

FIG. 1 depicts a system that includes transmitters and an assistance data source that form part of a first wireless network (network A) used to estimate the position of a first receiver, and further includes a transmitter and an assistance data source that form part of a second wireless network (network B) used to estimate the position of a second receiver.

FIG. 2 depicts a first receiver receiving positioning signals from a transmitter of a first network and receiving assistance data associated with the first network from an assistance data source of the first network, and further depicts a second receiver receiving positioning signals from a transmitter of a second network and receiving assistance data associated with the second network from an assistance data source of the second network.

FIG. 3 depicts a first receiver receiving positioning signals transmitted by a transmitter of a second network and receiving assistance data associated with the second network from an assistance data source.

FIG. 4 depicts a second receiver receiving positioning signals transmitted by a transmitter of a first network and receiving assistance data associated with the first network from an assistance data source.

FIG. 5 depicts a first receiver and a second receiver receiving positioning signals transmitted by a transmitter of a first network and receiving assistance data associated with the first network from an assistance data source while the first receiver and the second receiver are in a first coverage area.

FIG. 6 depicts a first receiver and a second receiver receiving positioning signals transmitted by a transmitter of a second network and receiving assistance data associated with the second network from an assistance data source while the first receiver and the second receiver are in a second coverage area.

FIG. 7 depicts a location server of a first network and a location server of a second network using a remote assistance data source to store and share assistance data associated with the first network and assistance data associated with the second network.

FIG. 8 depicts a location server of the first network and a location server of the second network sharing assistance data with each other.

FIG. 9 depicts alternative embodiments where assistance data may be accessed from assistance data sources of one or more of three networks.

FIG. 10A details a process for estimating a position of a first receiver of a first network using a positioning signal from a second network.

FIG. 10B details a process continuing from FIG. 10A for estimating a position of the first receiver using a positioning signal from the first network.

FIG. 11 details a process for receiving assistance data.

FIG. 12 details a process for receiving assistance data.

FIG. 13 details a process for receiving assistance data.

FIG. 14 details a process for receiving assistance data.

FIG. 15 details a process for receiving assistance data.

FIG. 16 details a process for receiving assistance data.

FIG. 17 details a process for configuring the first receiver to receive a positioning signal from a transmitter of the second network.

FIG. 18 details a process for estimating the position of the first receiver using a location server of the first network.

FIG. 19 details a process for estimating the position of the first receiver using a location server of the second network.

FIG. 20 details a process for estimating the position of the first receiver using a location server of a third network.

FIG. 21 details a process for estimating a position of the first receiver using a positioning signal from the second network, and further estimating a position of a second receiver using the positioning signal from the second network.

FIG. 22 details a process for estimating a position of a first receiver using a positioning signal from a first network when the first receiver is in a first coverage area, and for estimating a position of the first receiver using a positioning signal from a second network when the first receiver is not in the first coverage area.

FIG. 23 details a process continuing from FIG. 22 for estimating a position of a second receiver using the positioning signal from the first network when the second receiver is in the first coverage area, and for estimating a position of the second receiver using the positioning signal from the second network when the second receiver is not in the first coverage area.

FIG. 24 details a process for estimating the position of a first receiver using a positioning signal from a second network when the first receiver is not in a first coverage area, or in the first coverage area during a first time period, and for estimating the position of the first receiver using a positioning signal from a first network when the first receiver is in the first coverage area during a second time period.

FIG. 25 details a process for estimating the position of a second receiver using a positioning signal from a second network when the second receiver is not in a first coverage area, or in the first coverage area during a first time period, and for estimating the position of the second receiver using a positioning signal from a first network when the second receiver is in the first coverage area during a second time period.

### DETAILED DESCRIPTION

As mentioned in the Background section, network operators often must dedicate a portion of their spectrum for transmission of signaling related to determining the positions of receivers. Instead of each operator concurrently allocating a portion of their spectrum for transmission of such signaling within a particular coverage area, partnering operators could share or delegate that duty between themselves or even delegate the responsibility to another operator. Approaches for sharing or delegating the transmission of positioning signals to receivers are described below.

For instance, in one geographic region, a particular operator from among a plurality of operators may be selected to transmit positioning signals using that operator's spectrum, and receivers serviced by any of the operators may use those positioning signals. Also, different spectrums of different operators can be used to transmit positioning signals to the receivers at different times, and/or different spectrums of different operators can be used to transmit positioning signals to receivers in different geographic regions. Further details about each of these approaches are provided below following a brief description of systems that are implicated by these approaches.

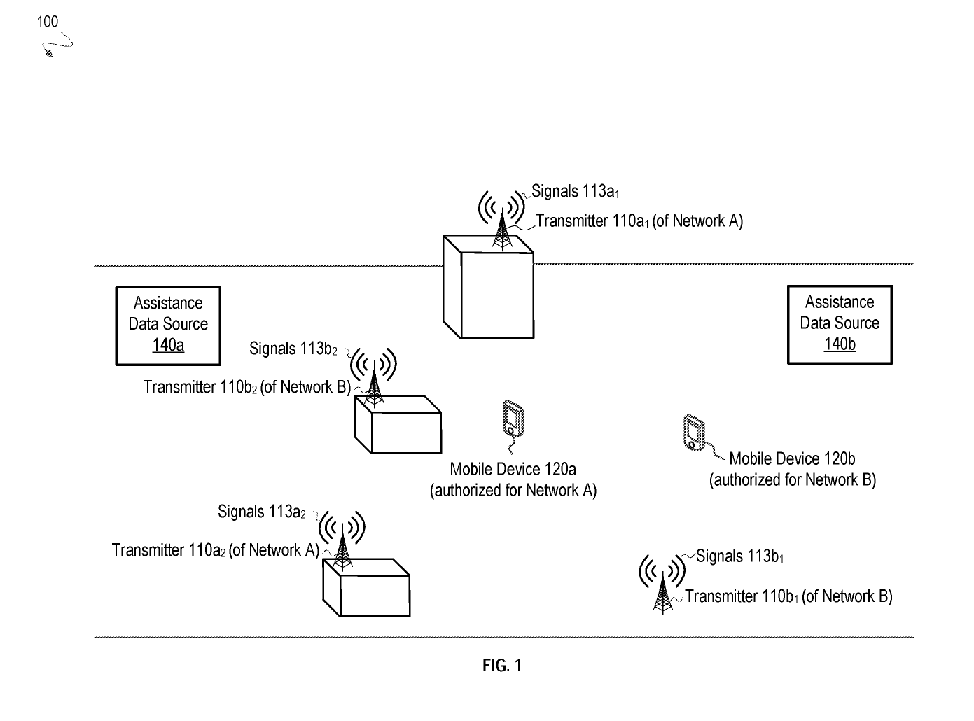

FIG. 1 depicts a system 100 that includes transmitter 110a₁, transmitter 110a₂, and an assistance data source 140a that form part of a first wireless network (network A) used to estimate the position of a first receiver 120a. The system 100 further includes transmitter 110b₁, transmitter 110b₂, and an assistance data source 140b that form part of a second wireless network (network B) used to estimate the position of a second receiver 120b. Each of the networks may include a wireless cellular phone network, a terrestrial positioning network, or another network. Although not shown, each network may include additional transmitters.

As shown, the first receiver 120a is authorized to use the first network for sending signals (e.g. texts, certain phone calls, data, or other transmittable signal) through the first network, but is not authorized to use the second network for sending signals through the second network. For example, the first receiver 120a may be a subscriber of the first network, but is not a subscriber of the second network.

Similarly, the second receiver 120b is authorized to use the second network for sending signals through the second network, but is not authorized to use the first network for sending signals through the first network. For example, the second receiver 120b may be a subscriber of the second network, but is not a subscriber of the first network.

To estimate a position of the first receiver 120a, transmitters of the first network (e.g. the transmitters 110a₁, 110a₂ and other transmitters not shown) transmit positioning signals (e.g. signals 113a₁, 113a₂ and others not shown) that are received by the first receiver 120a, and used to compute pseudorange distances between the receiver 120a and each of the transmitters. The pseudorange distances can be used with assistance data (e.g. position information for each of the transmitter) from the assistance data source 140a to generate an estimated position of the first receiver 120a as is known in the art. The position of the second receiver 120b is generated in a similar way, but using signals transmitted from transmitters in the second network (e.g. the transmitters 110b₁, 110b₂ and other transmitters not shown) and assistance data from the assistance data source 140b.

The assistance data sources 140a and 140b may be a terrestrial transmitter, a server, a satellite, a Wi-Fi access point, a Bluetooth beacon, a database residing on the receiver, or another source of data. An assistance data source provides information needed to generate an estimated position of a receiver. In some embodiments, such information may include data from an operator's eNodeB position database, Observed Time Difference of Arrival (OTDOA) assistance data as set forth by 3GPP, or other data. More details and additional examples of the contents and sharing of the assistance data will be discussed later.

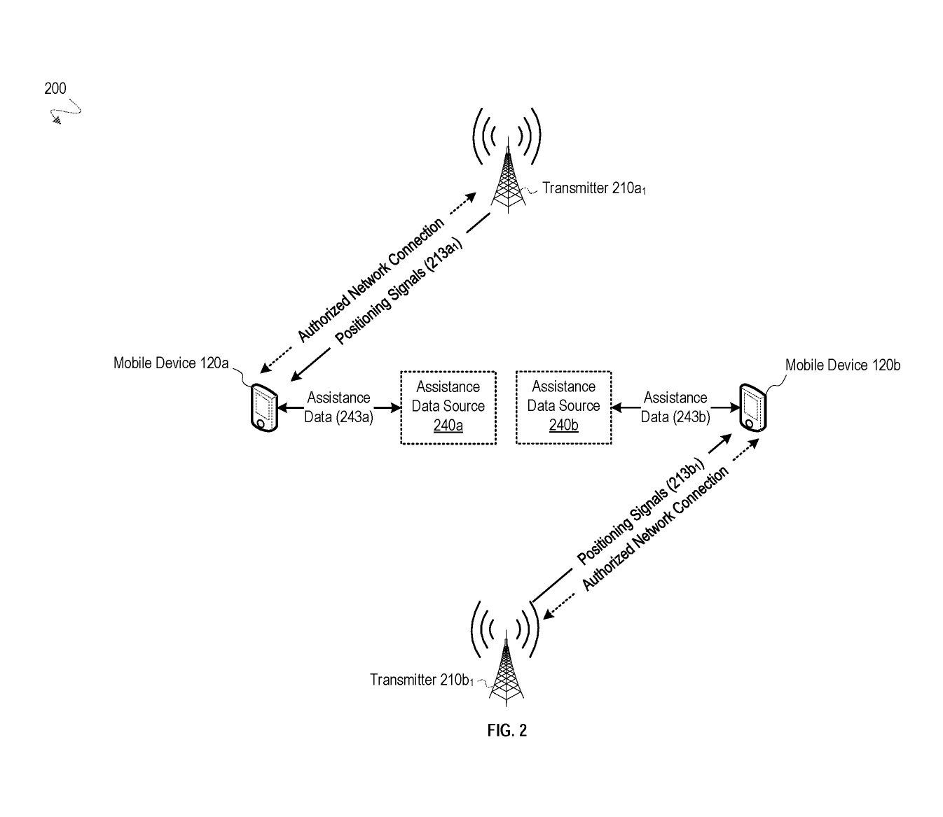

A scenario where positioning signals and assistance data are only provided to a receiver by the network the receiver is authorized to use (e.g. the network through which the receiver is permitted to send signals) is illustrated in FIG. 2. As shown, the first receiver 120a receives positioning signals 213a₁ from a transmitter 210a₁ of the first network and further receives assistance data 243a associated with the first network from an assistance data source 240 of the first network. The receiver 120a is authorized to send signals through the first network and is not authorized to send signals through the second network. The second receiver 120b receives positioning signals 213b₁ from a transmitter 210b₁ of the second network and further receives assistance data 243b associated with the second network from an assistance data source 240b of the second network. The receiver 120b is authorized to send signals through the second network and is not authorized to send signals through the first network.

### Shared Positioning Signals for OTDOA

As discussed earlier, and as illustrated in FIG. 1 and FIG. 2, the operator of the first network and the operator of the second network may each be using a percentage of their respective RF spectrum bandwidths providing positioning signals to the authorized receiver 120a and the authorized receiver 120b even though the receiver 120a and the receiver 120b may both be in the same region and could receive the same positioning signals transmitted from the same source if permitted to do so. As described below, the operators of the first network and the second network may share or delegate the duties of providing positioning signals to both of the receivers 120a and 120b in order to reduce the amount of their RF spectrum that is used for providing positioning signals.

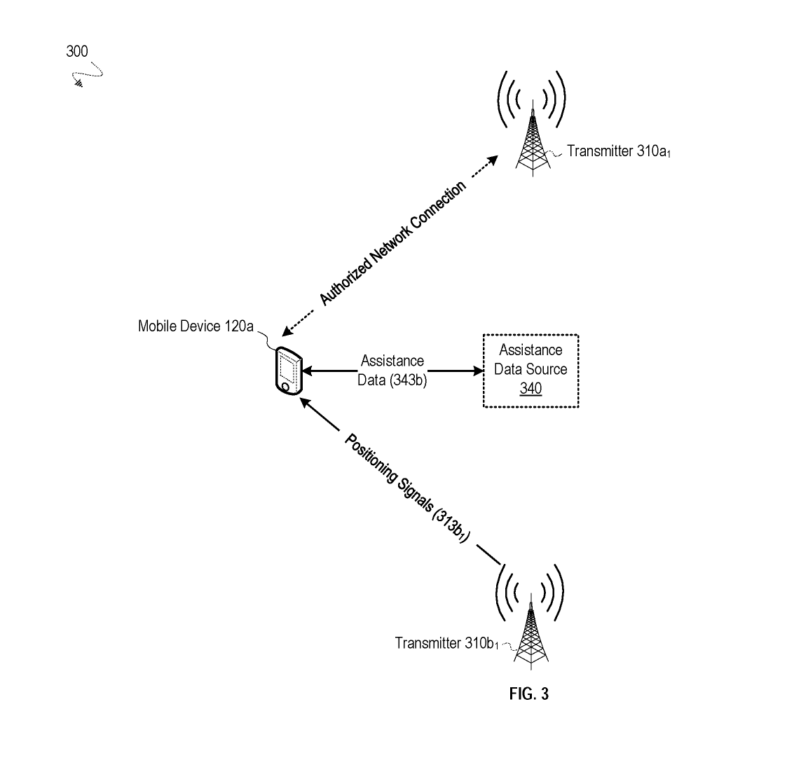

By way of example, a first example of how the duties of providing positioning signals to receivers are shared or delegated is depicted in FIG. 3. As shown, the first receiver 120a receives positioning signals 313b₁ transmitted by a transmitter 310b₁ of the second network, and further receives assistance data 343b associated with the second network from an assistance data source 340.

In order for the first receiver 120a to receive the positioning signals 313b₁ from the transmitter 310b₁ of the second network, the first receiver 120a may need to use signal timing information (e.g. transmission time slot) and signal tuning information (e.g. signal carrier frequency, PRN codes, etc.), which may be received as part of the assistance data 343b that is associated with the transmitter 310b₁. Also, in order to generate an estimated position of the first receiver 120a, the position coordinates (e.g. LLA) of the transmitter 310b₁, and the position coordinates of any other transmitter from which the first receiver 120a receives positioning signals, may be provided as part of the assistance data 343b that is associated with the transmitter 310b₁.

For example, if the transmitters of the second network are eNodeB's, the assistance data 343b may include eNodeB almanac data for each of the transmitters of the second network that are within a range of the first receiver 120a. The assistance data 343b may also include network synchronization parameters to assist the first network and the second network to synchronize the clocks of their transmitters and to exchange timing error corrections.

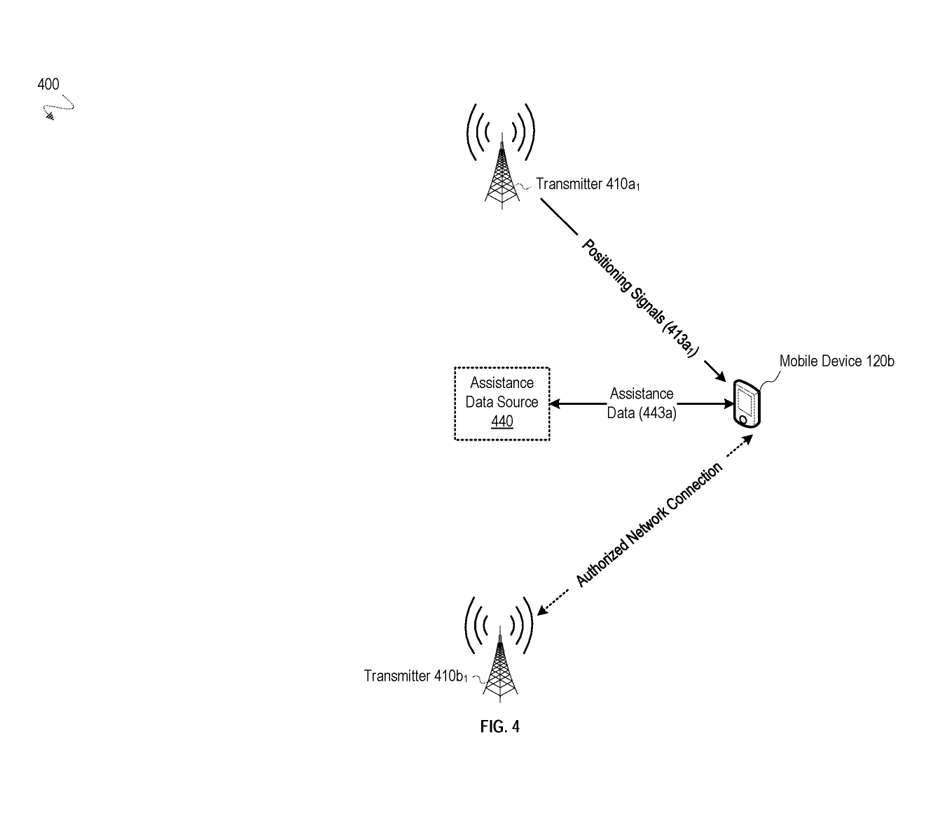

By way of example, a second example of how the duties of providing positioning signals to receivers are shared or delegated is depicted in FIG. 4. As shown, the second receiver 120b receives positioning signals 413a₁ transmitted by a transmitter 410a₁of the first network, and further receives assistance data 443a associated with the first network from an assistance data source 440. In order for the second receiver 120b to receive the positioning signals 413a₁ from the transmitter 410a₁ of the first network, the receiver 120b may need to use signal timing and tuning information identified within the assistance data 443a.

### Shared Positioning within a Coverage Area

The operators of the first and second networks may also arrange to have one operator provide positioning signals in a first overlapping geographic coverage area of the two networks, and to have another operator provide positioning in a second overlapping geographic coverage area of the two networks.

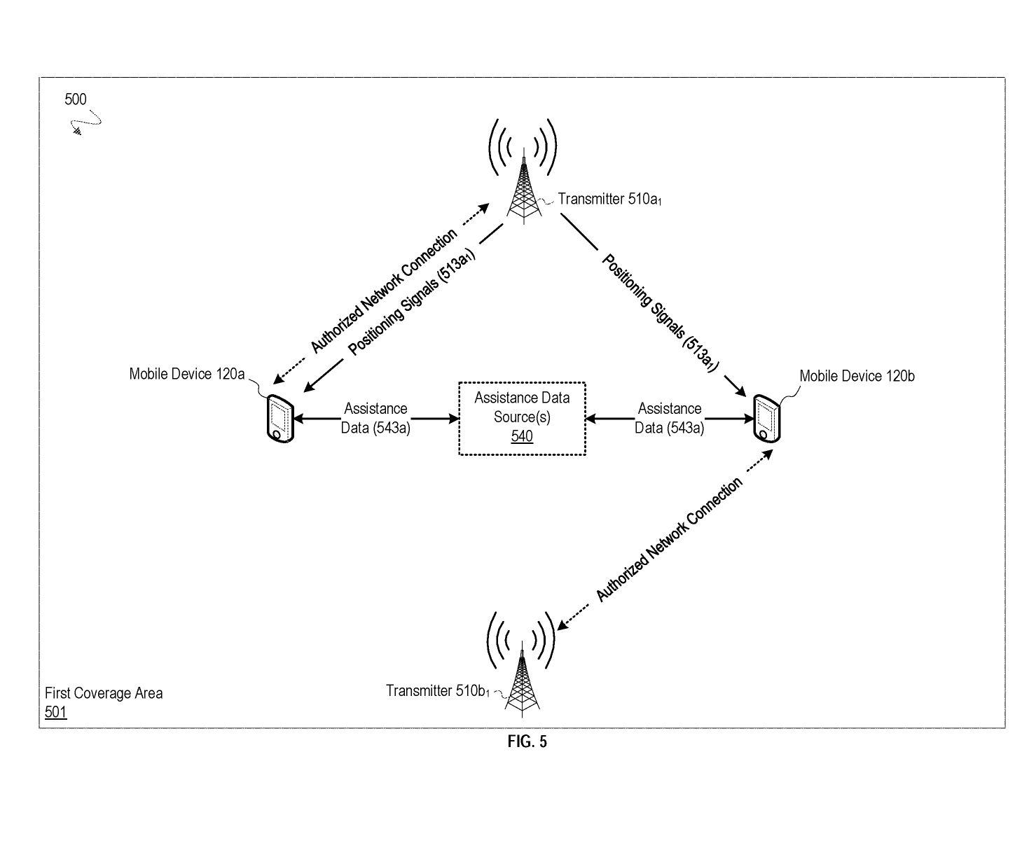

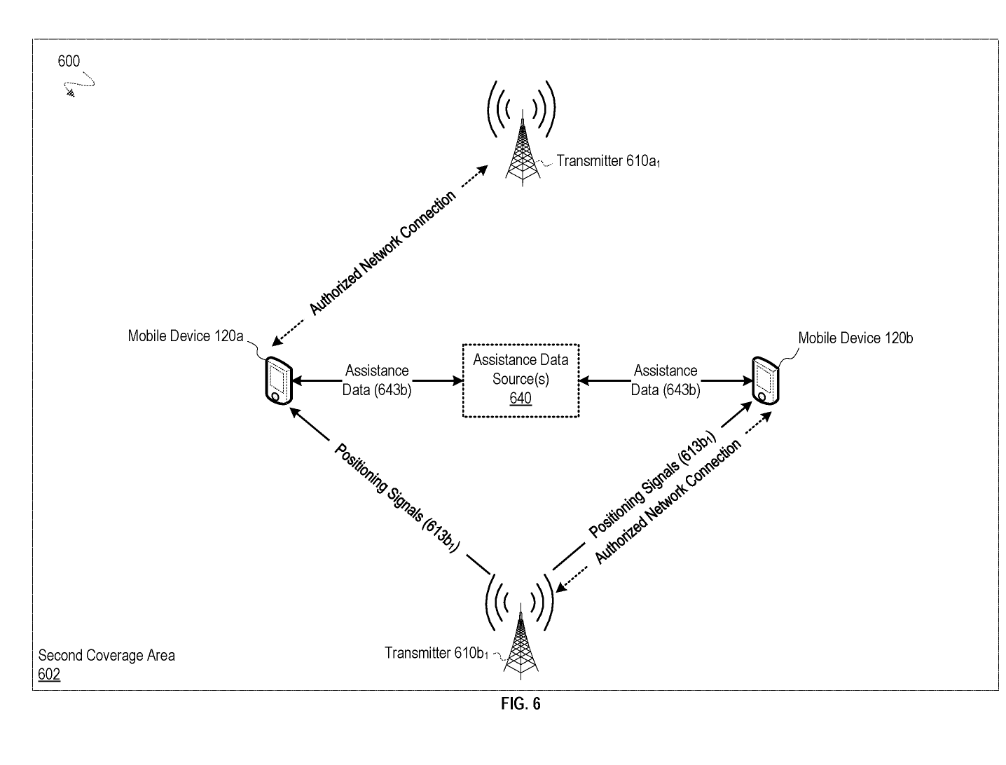

For example, the operator of the first network may agree to provide positioning signals to receivers of both the first and second network while the receivers are within a first coverage area, cell site, or region. Likewise, the operator of the second network may agree to provide positioning signals to receivers of both the first and second network while the receivers are within a second coverage area, cell site, or region. Details of positioning signal sharing between coverage areas will be shown next in FIG. 5 and FIG. 6.

In FIG. 5, the first receiver 120a of FIG. 1 receives positioning signals 513a₁ transmitted by a transmitter 510a₁ of the first network and receives assistance data 543a associated with the first network from one of one or more assistance data source(s) 540 while the first receiver 120a is in a first coverage area 501. The second receiver 120b of the second network also receives the positioning signals 513a₁ from the transmitter 510a₁ while the second receiver 120b is within the first coverage area 501 even though the second receiver 120b is not authorized to send signals through the first network. To receive the positioning signals transmitted from transmitters of the first network, the second receiver 120b may need assistance data associated with the first network in order to tune to the carrier frequency of the positioning signals 513a₁ as well as identify the periodicity of their transmission from the transmitter 510a₁. Such assistance data may be provided by one of one or more assistance data source(s) 540. The one or more assistance data source(s) 540 may be an assistance data source in the first network, an assistance data source in the second network, and/or an assistance data source in a third network.

A scenario where an operator of the second network may agree to provide positioning signals to the receiver 120a and the receiver 120b in a second coverage area 602 is depicted in FIG. 6. As shown, the first receiver 120a receives positioning signals 613b₁ transmitted by a transmitter 610b₁ of the second network and receives assistance data 643b associated with the second network from one of one or more assistance data source(s) 640 while the first receiver 120a is in the second coverage area 602. The second receiver 120b receives positioning signals 613b₁ transmitted by a transmitter 610b₁ of the second network and receives assistance data 643b associated with the second network from one of one or more assistance data source(s) 640 while the second receiver 120b is in the second coverage area 602. The one or more assistance data source(s) 640 may be an assistance data source in the first network, an assistance data source in the second network, and/or an assistance data source in a third network

### Assistance Data Synchronization and Sharing

As mentioned above, a receiver may need assistance data associated with a network of transmitters through which it is not authorized to transmit signaling so the receiver can receive positioning signals transmitted from that network. For example, this assistance data may include existing 3GPP defined OTDOA assistance data associated with the network that is transmitting the positioning signals, transmitter timing correction data, positional information of the transmitters, or other data.

There are many ways in which the assistance data may be shared between network operators which have agreed to share or delegate the duties of providing positioning signals to receivers.

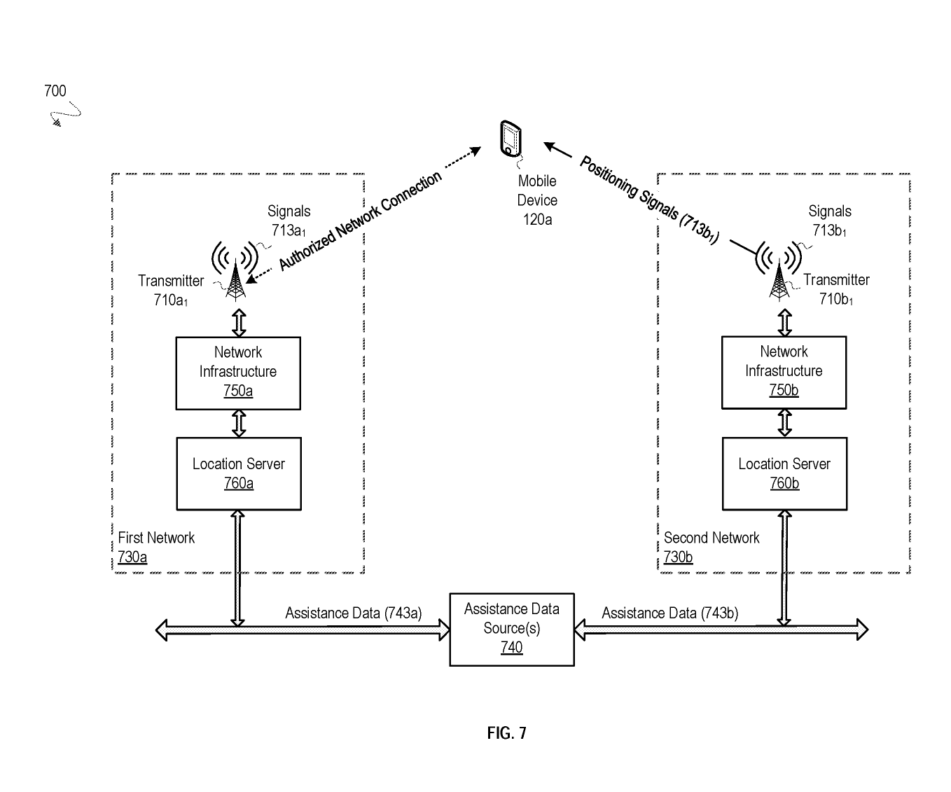

For example, in FIG. 7, a location server 760a of a first network 730a and a location server 760b of a second network 730b use an assistance data source 740 (e.g. a server) to store and share assistance data 743a associated with the first network 730a and assistance data 743b associated with the second network 730b. A location server may include a Serving Mobile Location Center (SMLC), an Evolved Serving Mobile Location Center (e-SMLC) (e.g. a component of an operator's network responsible for estimating the position of receiver within the operator's network), or another suitable server. The assistance data source 740 may form part of first network 730a, the second network 730b, or a third network (not shown). As shown, the assistance data 743a of the first network 730a and the assistance data 743b of the second network 730b is accessible to either network, and the location server 760a can access the assistance data 743b when generating an estimated position of the receiver 120a using the positioning signals 713b₁ received by the receiver 120a from the transmitter 710b₁.

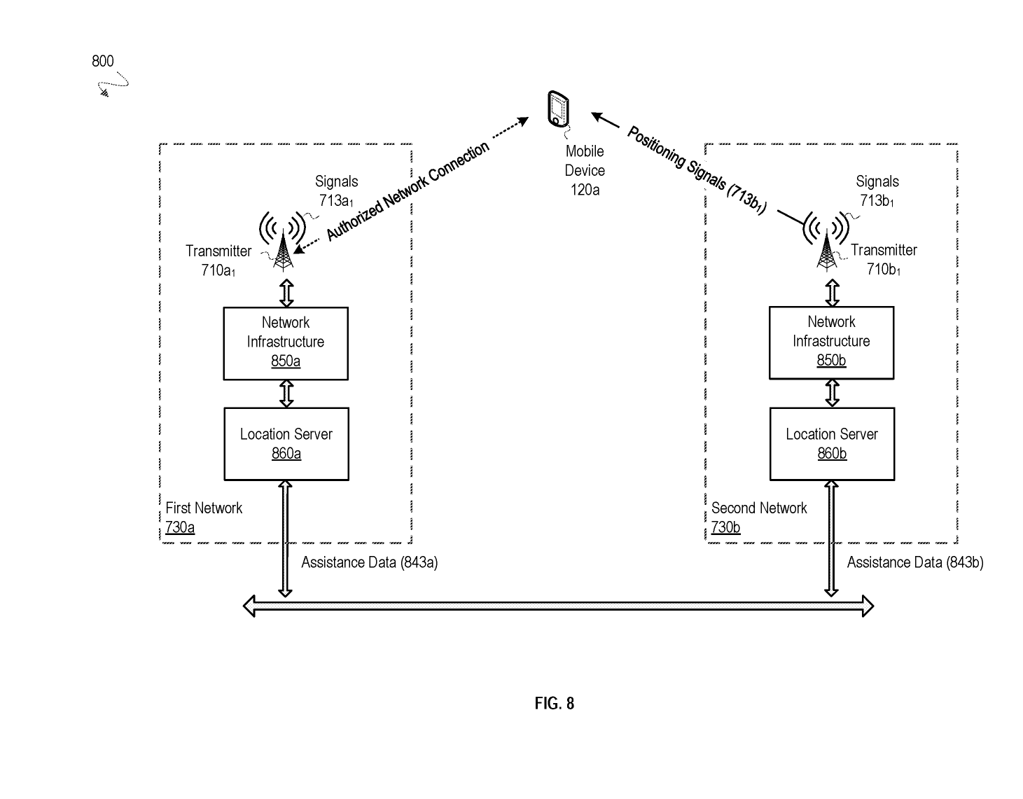

In FIG. 8, a location server 860a of the first network 730a and a location server 860b of the second network 730b share assistance data 843a and assistance data 843b with each other. When the location server 860a needs to generate an estimated position of the receiver 120a using the positioning signals 713b₁ received by the receiver 120a from the transmitter 710b₁, it sends a request to the location server 860b for assistance data associated with the second network 730b. The location server 860b can then provide the assistance data 843b to the location server 860a in support of estimating the position of the receiver 120a.

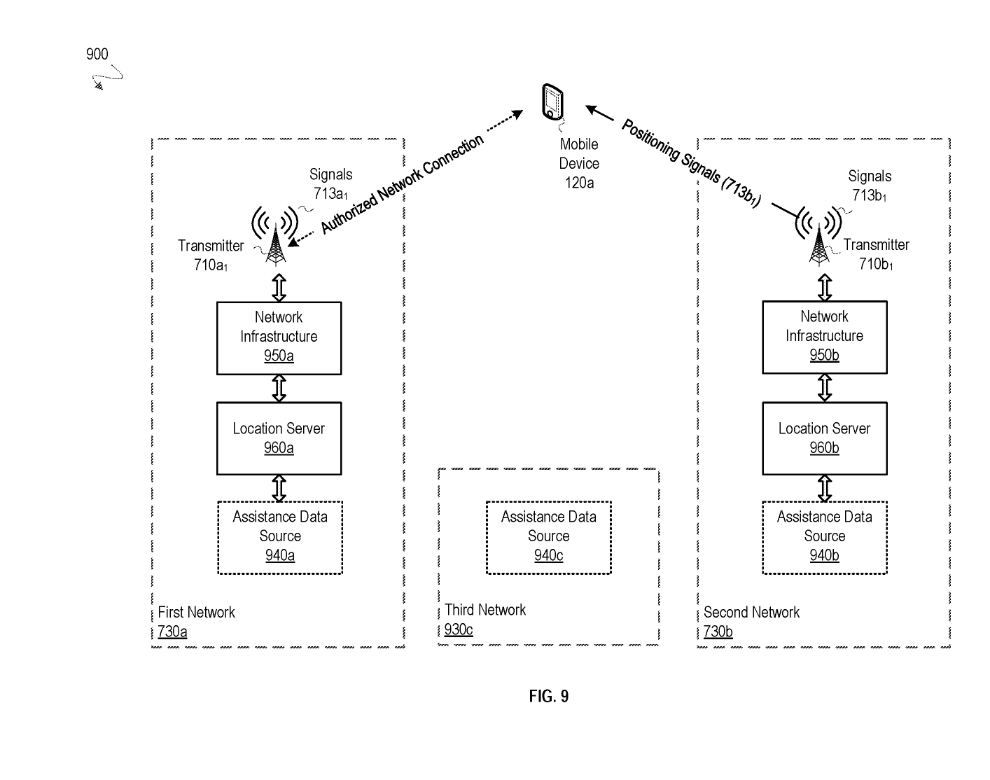

Alternative embodiments where assistance data may be stored at and accessed from assistance data sources of one or more of three networks are illustrated in FIG. 9. As shown, an assistance data source 940a may form part of the first network 730a; an assistance data source 940b may be part of the second network 730b; and/or an assistance data source 940c may be part of a third network 930c. The assistance data associated with the first network 730a and the second network 730b may be stored at one or more of the assistance data sources 940a, 940b and/or 940c to be accessed by the location server 960a, the location server 960b, and/or the receiver 120a.

### Example Processes for Providing Positioning Signals to Receivers of Different Networks

Attention is now turned to processes used to share or delegate the duties of providing positioning signals between different networks.

Different types of networks are contemplated, including any type of terrestrial transmitter network, wireless cellular networks, local area networks, networks operated by different network operators, and/or other types of networks. The networks may be synchronized with each other in certain embodiments.

Positioning signals may be any type of positioning signal, including Long Term Evolution (LTE) Positioning Reference Signals (PRS). The positioning signals may be received by a receiver from one or more sources, including transmitters of a first network (e.g. through which the receiver is authorized to transmit signals), transmitters of a second network (e.g. through which the receiver is not authorized to transmit signals), transmitters of a third network (e.g. through which the receiver is not authorized to transmit signals), or another source.

Assistance data associated with a network may be any type of assistance data, including data that specifies identifiers, timing information, and position coordinates for each of the transmitters in a respective network. The assistance data may be received by a receiver from one or more sources, including a server of the first network, a server of the second network, a server of the third network, or another source. When more than one of the sources provide the assistance data to the receiver, each of those sources may provide the same assistance data or different parts of the assistance data.

The received positioning signals and assistance data may be used to estimate a position of the receiver using know techniques like trilateration or other techniques. Estimation of the position may be carried out by the receiver, by the first network, by the second network, by the third network, or by another source.

A process for estimating a position of the first receiver (which is authorized to transmit signals through a first network) using a positioning signal (e.g. a PRS signal) from a second network through which the first receiver is not authorized to transmit signals is detailed in FIG. 10A. The process includes the steps of: receiving, at the first receiver, assistance data associated with the second network (step 1005); receiving, at the first receiver, positioning signal(s) from transmitter(s) of the second network (step 1010); and estimating a position of the first receiver using the positioning signal(s) and the assistance data (step 1015). As previously discussed, in order for the first receiver to receive the positioning signal from the transmitter of the second network, the first receiver may need to identify and tune to the transmission channel associated with positioning signals transmitted by transmitters of the second network. Such information may be contained in the assistance data received by the first receiver at step 1005.

A process for estimating a position of the first receiver using a positioning signal from the first network is detailed in FIG. 10B. The steps of the process include: receiving, at the first receiver, assistance data associated with the first network (step 1020); receiving, at the first receiver, a positioning signal from a transmitter of the first network (step 1025); and estimating a second position of the first receiver using the positioning signal from the first network and the assistance data associated with the first network (step 1030). This process is useful where positioning signals transmitted from the first and second networks are transmitted in different coverage areas, or are selectively transmitted based on agreed upon time periods. Specifics of time-based sharing processes will be discussed later.

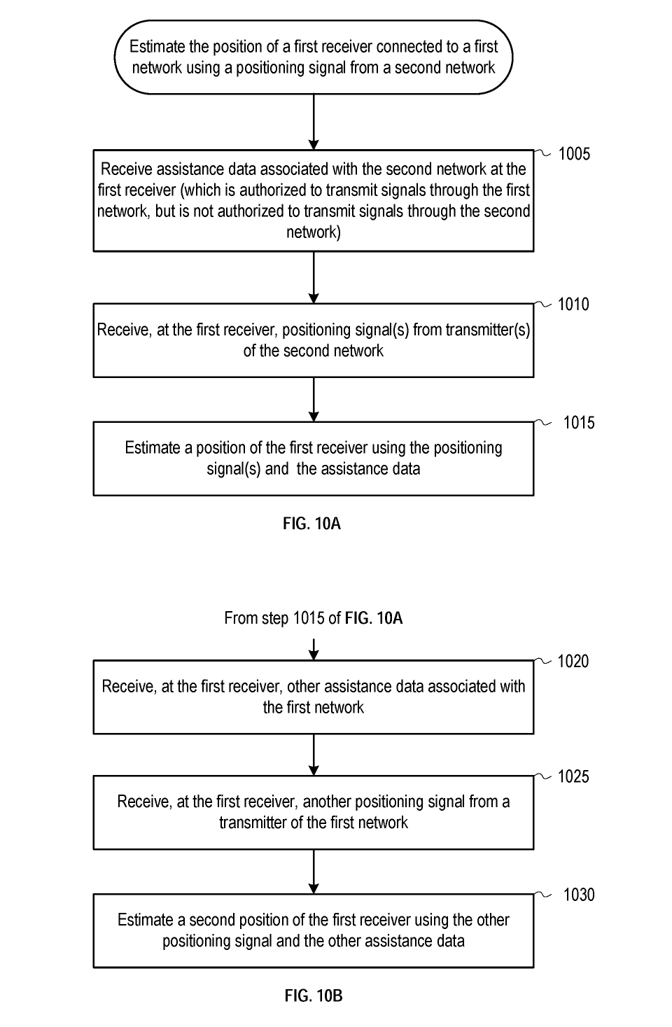

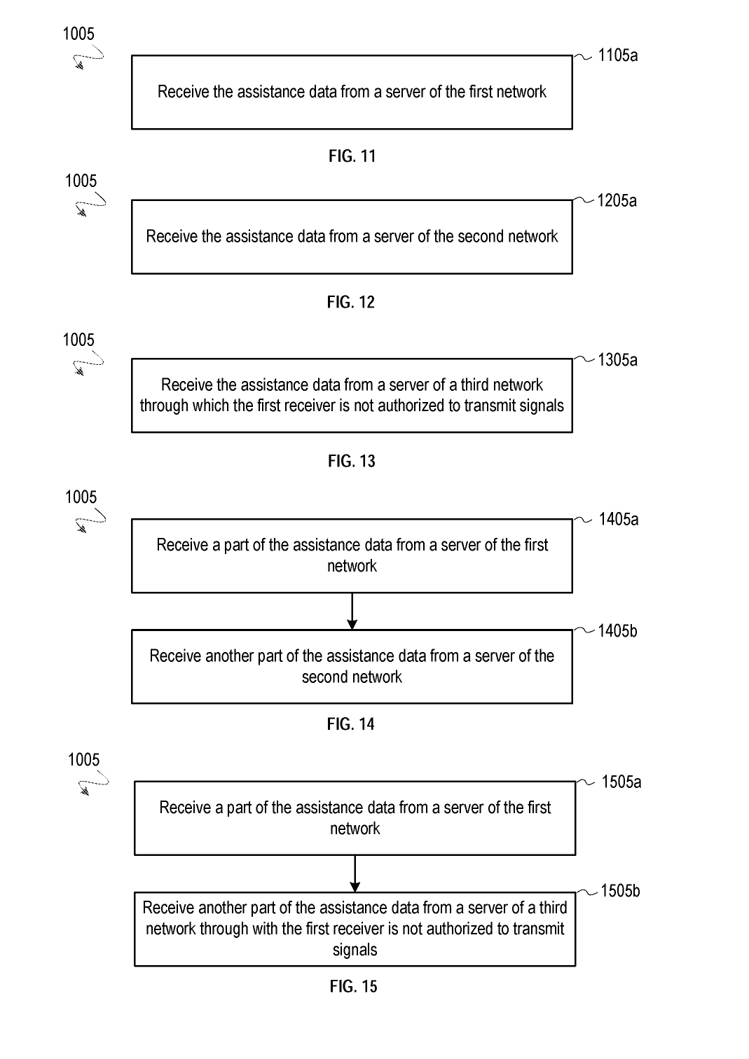

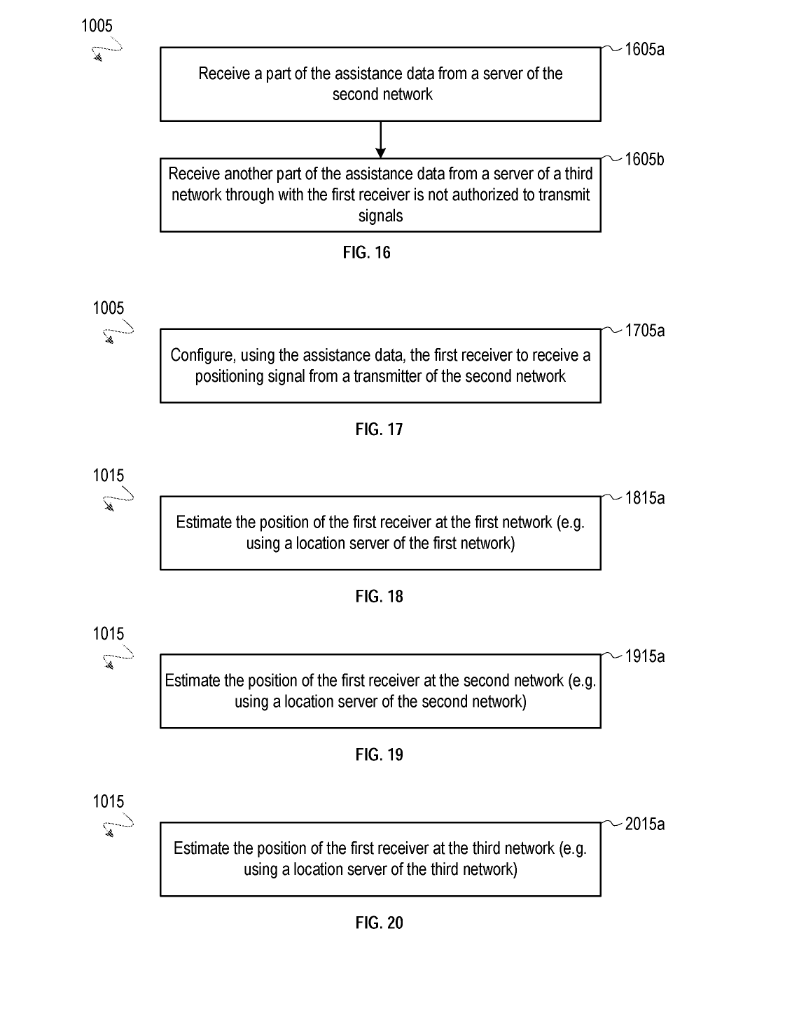

Attention is now drawn to FIG. 11 through FIG. 16, which detail alternative process steps for receiving the assistance data at the first receiver (e.g. during step 1005 of FIG. 10A). The alternative steps include: receiving the assistance data from a server of the first network (step 1105a of FIG. 11); receiving the assistance data from a server of the second network (step 1205a of FIG. 12); receiving the assistance data from a server of a third network through which the first receiver is not authorized to transmit signals (step 1305a of FIG. 13); receiving a portion of the assistance data from a server of the first network, and receiving another portion of the assistance data from a server of the second network (steps 1405a and 1405b of FIG. 14); receiving a portion of the assistance data from a server of the first network, and receiving another portion of the assistance data from a server of the third network through which the first receiver is not authorized to transmit signals (steps 1505a and 1505b of FIG. 15); or receiving a portion of the assistance data from a server of the second network, and receiving another portion of the assistance data from a server of the third network (steps 1605a and 1605b of FIG. 16).

As shown in FIG. 17, the assistance data may be used to configure the first receiver to receive a positioning signal from a transmitter of the second network (1705a), as is known in the art.

Attention is now drawn to FIG. 18 through FIG. 20, which detail alternative process steps for estimating the position of the first receiver (e.g. during step 1015 of FIG. 10A). The alternative steps include: estimating the position of the first receiver at the first network (e.g. using a location server of the first network) (step 1815a of FIG. 18); estimating the position of the first receiver at the second network (e.g. using a location server of the second network) (step 1915a of FIG. 19); or estimating the position of the first receiver at the third network (e.g. using a location server of the third network) (step 2015a of FIG. 20).

### Receiving Positioning Signals at a Receiver of a Second Network

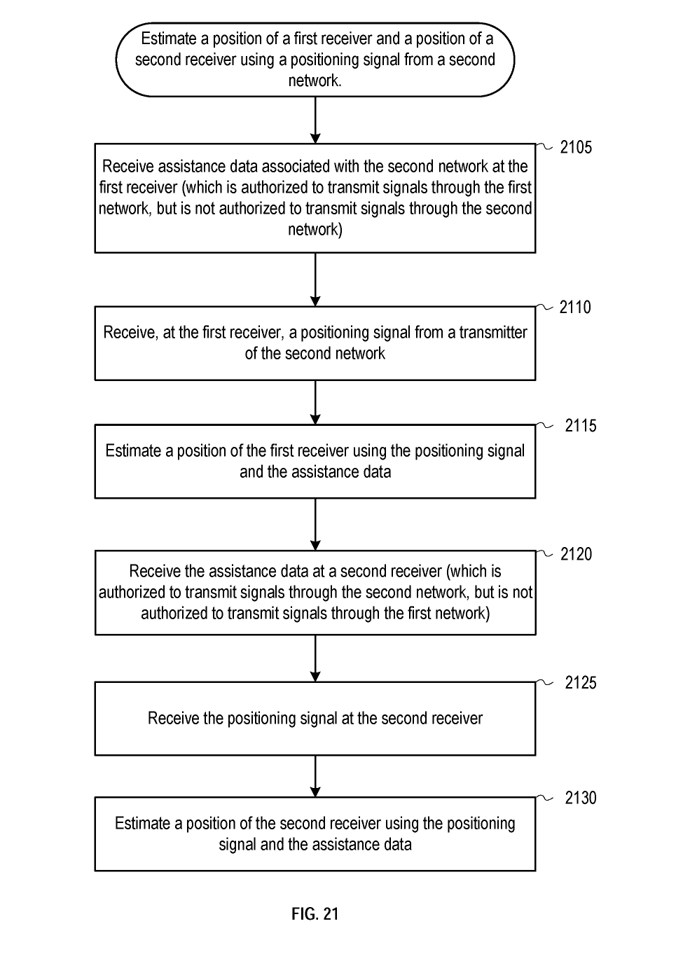

In a scenario in which the duties of transmitting positioning signals is shared or delegated, there may be regions and times in which a receiver will receive positioning signals transmitted from the network through which they are authorized to transmit signals. For example, a process for estimating a position of the first receiver using a positioning signal from the second network, and further estimating a position of a second receiver using the positioning signal from the second network is detailed in FIG. 21. The process includes the steps of: receiving, at the first receiver, assistance data associated with the second network (step 2105); receiving, at the first receiver, a positioning signal from a transmitter of the second network (step 2110); estimating a position of the first receiver using the positioning signal and the assistance data (step 2115); receiving the assistance data at the second receiver (step 2120); receiving the positioning signal at the second receiver (step 2125); and estimating a position of the second receiver using the positioning signal and the assistance data (step 2130). In one embodiment, the position of the first receiver is estimated by the first network, and the position of the second receiver is estimated by the second network. In other embodiments, the same network (e.g. the first network or the second network) estimates both positions.

### Example Process for providing Positioning Signals Based on a Coverage Area

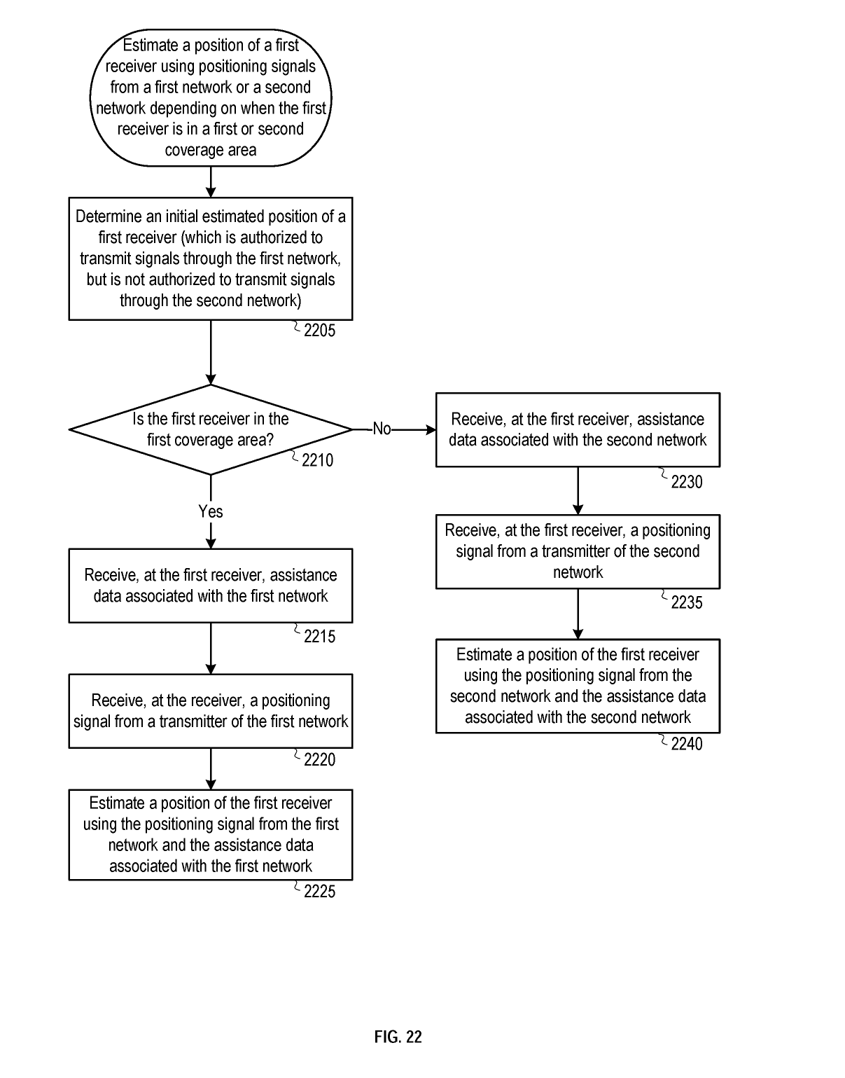

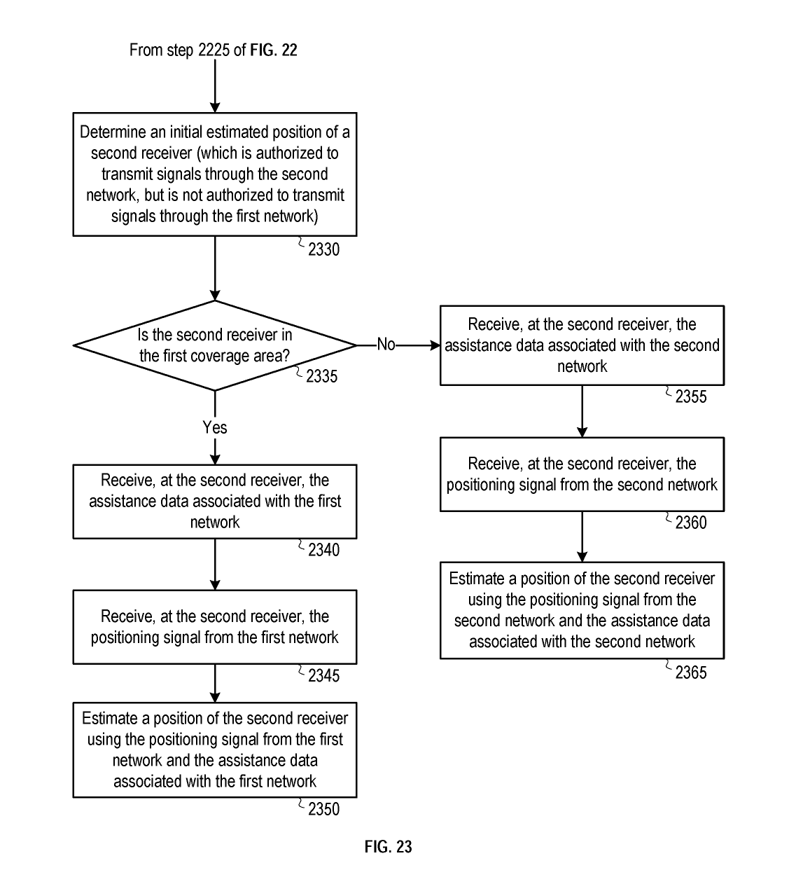

Operators may agree to share the duties of providing positioning signals based on a geographical coverage area, where a first network provides positioning signals within a first coverage area, and a second network provides positioning signals within a second coverage area. A process for estimating a position of the first receiver using a positioning signal from the first network when the first receiver is in a first coverage area, and for estimating a position of the first receiver using a positioning signal from the second network when the first receiver is not in the first coverage area is detailed in FIG. 22. The process includes the steps of: determining an initial estimated position of the first receiver (e.g. using GNSS) (step 2205); and determining, using the initial estimated position, if the first receiver is in the first coverage area (step 2210). If the first receiver is in the first coverage area, the process includes the steps of: receiving, at the first receiver, assistance data associated with the first network (step 2215); receiving, at the receiver, a positioning signal from a transmitter of the first network (step 2220); and estimating a position of the first receiver using the positioning signal from the first network and the assistance data associated with the first network (step 2225). Otherwise, if the first receiver is not in the first coverage area, the process includes the steps of: receiving, at the first receiver, assistance data associated with the second network (step 2230); receiving, at the first receiver, a positioning signal from a transmitter of the second network (step 2235); and estimating a position of the first receiver using the positioning signal from the second network and the assistance data associated with the second network (step 2240).

Based on the agreement between the operators, a second receiver that is not authorized to transmit signals through the first network, but is authorized to transmit signals through the second network may also receive positioning signals transmitted from transmitters of the first network when the second receiver is in the first coverage area. For example, a process for estimating a position of the second receiver using the positioning signal from the first network when the second receiver is in the first coverage area, and for estimating a position of the second receiver using the positioning signal from the second network when the second receiver is not in the first coverage area is detailed in FIG. 23. This process includes the steps of: determining an initial estimated position of the second receiver (step 2330); and determining, using the initial estimated position of the second receiver, if the second receiver in the first coverage area (2335). If the second receiver is in the first coverage area, the process includes the steps of: receiving, at the second receiver, the assistance data associated with the first network (step 2340); receiving, at the second receiver, the positioning signal from the first network (step 2345); and estimating a position of the second receiver using the positioning signal from the first network and the assistance data associated with the first network (step 2350). Otherwise, if the second receiver is not in the first coverage area, the process includes the steps of: receiving, at the second receiver, the assistance data associated with the second network (step 2355); receiving, at the second receiver, the positioning signal from the second network (step 2360); and estimating a position of the second receiver using the positioning signal from the second network and the assistance data associated with the second network (step 2365).

In order for the second receiver to receive the positioning signal from the transmitter of the first network, the second receiver may need to identify transmission channel and timing information associated with positioning signals transmitted by transmitters of the first network. Such information may be contained in the first assistance data received by the second receiver at step 2340. The assistance data associated with the first network may be used to configure the second receiver to receive the positioning signal(s) from the first network as is known in the art.

### Example Process for Sharing the Duty of providing Positioning Signals Based on a Time Period

Two or more wireless network operators may agree to share the duties of providing positioning signals to receivers of either network within a coverage area by identifying time periods during which one network operator makes positioning signals available.

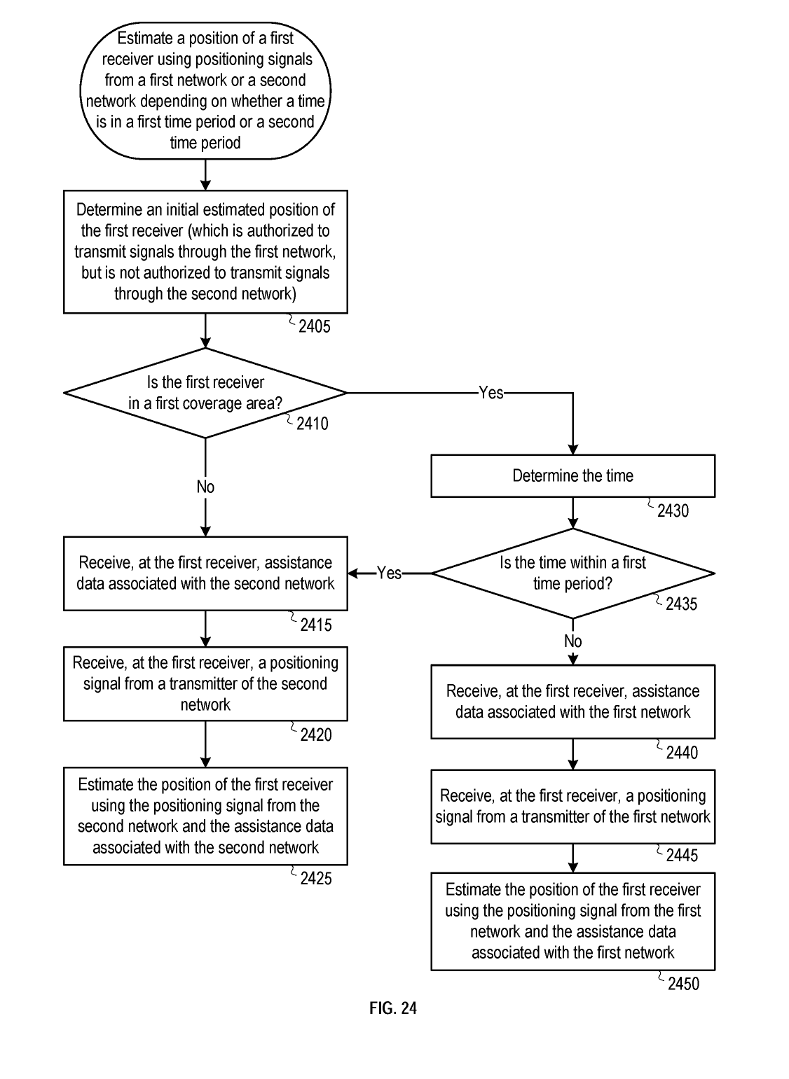

A process for estimating the position of the first receiver using a positioning signal from the second network when the first receiver is in the first coverage area during a first time period, and for estimating the position of the first receiver using a positioning signal from the first network when the first receiver is in the first coverage area during a second time period is detailed in FIG. 24. The process includes the steps of: determining an initial estimated position of the first receiver (step 2405); and determining, using the initial estimated position of the first receiver, if the first receiver is in the first coverage area (step 2410). If the first receiver is not in the first coverage area, the process includes the steps of: receiving, at the first receiver, assistance data associated with the second network (step 2415); receiving, at the first receiver, a positioning signal from a transmitter of the second network (step 2420); and estimating the position of the first receiver using the positioning signal from the second network and the assistance data associated with the second network (step 2425). Otherwise, if the first receiver is in the first coverage area, the process includes the steps of: determining the time (step 2430); and determining if the time is within a first time period (step 2435). If the time is within the first time period, the process includes the steps of: step 2415; step 2420; and step 2425. Otherwise, if the time is not within the first time period, the process includes the steps of: receiving, at the first receiver, assistance data associated with the first network (step 2440); receiving, at the first receiver, a positioning signal from a transmitter of the first network (step 2445); and estimating the position of the first receiver using the positioning signal from the first network and the assistance data associated with the first network (step 2450). By way of example, the first receiver is authorized to transmit signals through the first network, but is not authorized to transmit signals through the second network.

The time determined at step 2430 may include: a network time (e.g. Coordinated Universal Time) to which one or more of the transmitters from each of the networks is synchronized; a time synchronized to a satellite of the Global Navigation Satellite System (GNSS); a local time measured at a receiver; a local time measured at a transmitter; or another time.

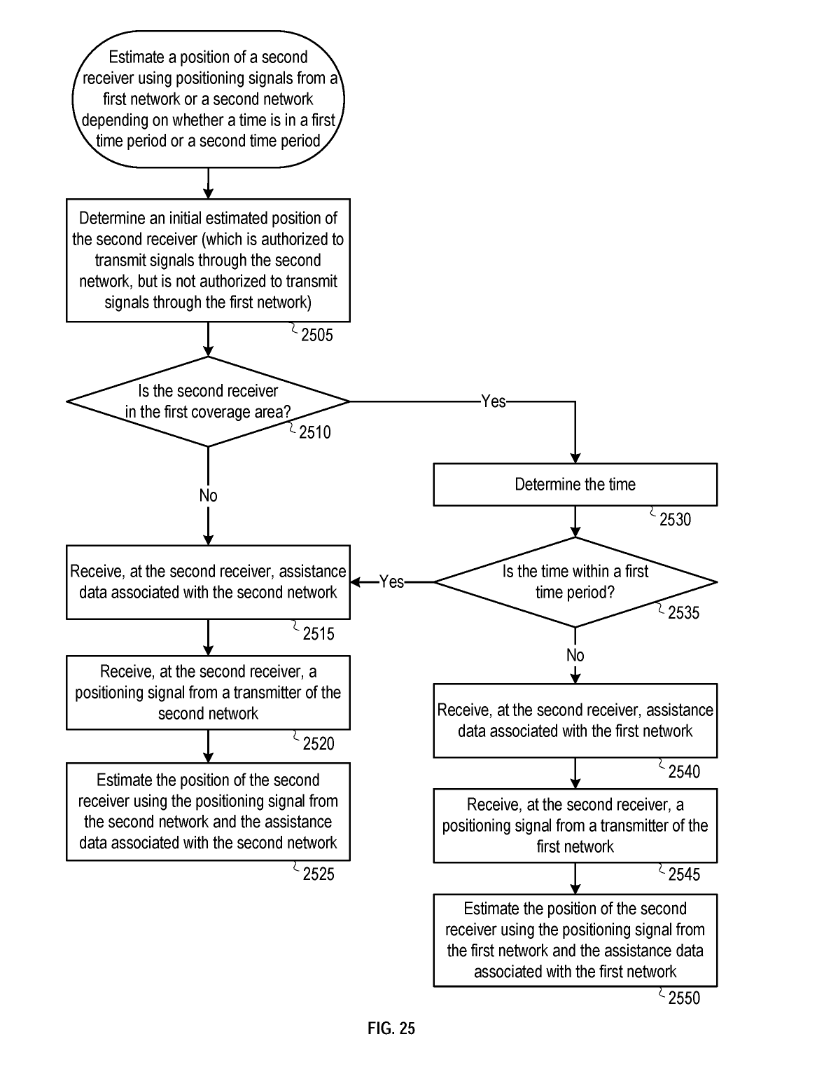

A process for estimating the position of the second receiver using a positioning signal from the second network when the second receiver is not in a first coverage area, or in the first coverage area during a first time period, and for estimating the position of the second receiver using a positioning signal from the first network when the second receiver is in the first coverage area during a second time period is detailed in FIG. 25. The steps of the process include: determining an initial estimated position of the second receiver (step 2505); and determining, using the initial estimated position of the second receiver, if the second receiver is in the first coverage area (step 2510). If the second receiver is not in the first coverage area, the process includes the steps of: receiving, at the second receiver, assistance data associated with the second network (step 2515); receiving, at the second receiver, a positioning signal from a transmitter of the second network (step 2520); and estimating the position of the second receiver using the positioning signal from the second network and the assistance data associated with the second network (step 2525). Otherwise, if the second receiver is in the first coverage area, the process includes the steps of: determining the time (step 2530); and determining if the time is within a first time period (step 2535). If the time is within the first time period, the process includes the steps of: step 2515; step 2520; and step 2525. Otherwise, if the time is not within the first time period, the process includes the steps of: receiving, at the second receiver, assistance data associated with the first network (step 2540); receiving, at the second receiver, a positioning signal from a transmitter of the first network (step 2545); and estimating the position of the second receiver using the positioning signal from the first network and the assistance data associated with the first network (step 2550). By way of example, the second receiver is authorized to transmit signals through the second network, but is not authorized to transmit signals through the first network.

### Example Process for Estimating a Receiver's Position Using Signals and Assistance Data from Two Networks

In some embodiments, a receiver's position may be estimated using positioning signals transmitted from more than one network (where the networks may or may not be synchronized). For example, one such process includes the steps of: receiving, at a first receiver authorized to transmit signals through a first terrestrial transmitter network, assistance data associated with terrestrial transmitters of a second terrestrial transmitter network through which the first receiver is not authorized to transmit signals; receiving, at the first receiver, one or more positioning signals transmitted from one or more transmitters of the second network; receiving, at the first receiver, assistance data associated with terrestrial transmitters of the first network; receiving, at the first receiver, positioning signals transmitted from the transmitters of the first network; and estimating a position of the first receiver using the positioning signals transmitted from the second network, the assistance data associated with the second network, the positioning signals transmitted from the first network, and the assistance data associated with the first network.

In one embodiment, the position of first receiver is estimated using trilateration, where the positioning signals transmitted from the second network are used to generate pseudoranges using known approaches for doing so, the assistance data associated with the second network is used to identify the locations of the transmitters in the second network from which the positioning signals were transmitted, the positioning signals transmitted from the first network are used to generate pseudoranges using known approaches for doing so, and the assistance data associated with the first network is used to identify the locations of the transmitters in the first network from which the positioning signals were transmitted.

### Other Aspects

In some embodiments described above, the same positioning signal transmitted from a transmitter is received by the first receiver and the second receiver (possibly at different times). However, in alternative embodiments, the same positioning signal is not received by the first receiver and the second receiver. Instead, different positioning signals transmitted from the same transmitter are received such that the first receiver receives one positioning signal from a transmitter (e.g. a transmitter in the first network, or a transmitter in the second network) and the second receiver receives another positioning signal from that transmitter. The same scenario can apply to assistance data where each of the first and second receivers receives different assistance data.

In at least one embodiment, a receiver is not “authorized” to transmit signals through a network even when that receiver is permitted to make an emergency call using the network. By way of example, a user with a receiver authorized to use a Verizon® network is not “authorized” to use (e.g. send non-emergency signaling through) a competitor network even though that user's receiver can send signaling needed to carry out an emergency call over the competitor network, where such signaling of the emergency call may include data to enable determining the position of the user. In some examples, not being authorized to transmit signals through a network means that the user does not have an account (prepay, monthly, or equivalent) with the network or a roaming partner of the network.

Methods of this disclosure may be implemented by hardware, firmware or software. One or more non-transitory machine-readable media embodying program instructions that, when executed by one or more machines, cause the one or more machines to perform any of the described methods are also contemplated. As used herein, machine-readable media includes all forms of statutory machine-readable media (e.g. statutory non-volatile or volatile storage media, statutory removable or non-removable media, statutory integrated circuit media, statutory magnetic storage media, statutory optical storage media, or any other statutory storage media). As used herein, machine-readable media does not include non-statutory media. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps performed by a transmitter or a receiver can be performed by a server, or vice versa.

Systems comprising one or more modules that perform or are operable to perform different method steps/stages disclosed herein are also contemplated, where the modules are implemented using one or more machines listed herein or other suitable hardware.

In one embodiment, a positioning system for transmitting positioning signals in support of estimating positions of receivers comprises: a first network of transmitters operated by a first network operator across a first set of coverage areas, the first network being operable to receive information from a first receiver and provide that information to a remote source; a second network of transmitters operated by a second network operator across a second set of coverage areas, the second network not being operable to receive information from the first receiver and provide that information to the remote source; a server of the first network, the second network, or a third network, the server being operable to provide assistance data associated with the second network of transmitters to the first receiver; and a location computation module operable to estimate the position of the first receiver using positioning signals transmitted from the second network and the assistance data associated with the second network.

When two things (e.g. modules or other features) are “coupled to” each other, those two things may be directly connected together (e.g. shown by a line connecting the two things in the drawings), or separated by one or more intervening things. Where no lines and intervening things connect two particular things, coupling of those things is contemplated unless otherwise stated. Where an output of one thing and an input of another thing are coupled to each other, information (e.g. data and/or signaling) sent from the output is received by the input even if the data passes through one or more intermediate things. All information disclosed herein may be transmitted over any communication pathway using any protocol. Data, instructions, commands, information, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e. not limited to) as opposed to an exclusive sense (i.e. consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g. a thing that may perform an operation or may have a characteristic need not perform that operation or have that characteristic in each embodiment, but that thing performs that operation or has that characteristic in at least one embodiment.

By way of example, transmitters described herein may include: antenna module(s) for exchanging signals with other systems (e.g. satellites, other transmitters, receivers, a server); RF front end module(s) with circuitry components (e.g. analog/digital logic and power circuitry, tuning circuitry, buffer and power amplifiers, and other components as is known in the art or otherwise disclosed herein); processing module(s) for performing signal processing (e.g. generating signals for transmission to other systems at a selected time, using a selected frequency, using a selected code, and/or using a selected phase), methods described herein, or other processing; memory module(s) for providing storage and retrieval of data and/or instructions relating to methods of operation described herein that may be executed by the processing module(s); sensors module(s) for measuring conditions at or near the transmitter (e.g. pressure, temperature, humidity, wind, or other conditions); and/or interface module(s) for exchanging information with other systems via other links other than a radio link. Signals transmitted by a transmitter may carry different information that, once determined by a receiver or a server, may identify the following: the transmitter that transmitted the signal; the location (LLA) of that transmitter; pressure, temperature, humidity, and other conditions at or near that transmitter; and/or other information.

A receiver may be in the form of a computing device (e.g. a mobile phone, tablet, laptop, digital camera, tracking tag). A receiver may also take the form of any component of the computing device, including a processor. By way of example, a receiver may include: antenna module(s) for exchanging signals with other systems (e.g. satellites, terrestrial transmitters, receivers); RF front end module(s) with circuitry components (e.g. mixers, filters, amplifiers, digital-to-analog and analog-to-digital converters as is known in the art or otherwise disclosed herein); processing module(s) for signal processing of received signals to determine position information (e.g. times of arrival or travel time of received signals, atmospheric information from transmitters, and/or location or other information associated with each transmitter), for using the position information to compute an estimated position of the receiver, for performing methods described herein, and/or for performing other processing; memory module(s) for providing storage and retrieval of data and/or instructions relating to methods of operation described herein that may be executed by the processing module(s) or other module(s); sensor module(s) for measuring environmental conditions at or near the receiver (e.g. pressure, temperature, humidity, wind), which may be compared to the same environmental conditions at or near transmitters to determine the altitude of the receiver; other sensor module(s) for measuring other conditions (e.g. acceleration, velocity, orientation, light, sound); interface module(s) for exchanging information with other systems via other links other than a radio link; and/or input/output module(s) for permitting a user to interact with the receiver. Processing by the receiver can also occur at a server.

It is noted that the term “positioning system” may refer to satellite systems (e.g. Global Navigation Satellite Systems (GNSS) like GPS, GLONASS, Galileo, and Compass/Beidou), terrestrial systems, and hybrid satellite/terrestrial systems.

Certain aspects disclosed herein relate to positioning modules that estimate the positions of receivers—e.g. where the position is represented in terms of: latitude, longitude, and/or altitude coordinates; x, y, and/or z coordinates; angular coordinates; or other representations. Positioning modules use various techniques to estimate the position of a receiver, including trilateration, which is the process of using geometry to estimate the position of a receiver using distances traveled by different “positioning” (or “ranging”) signals that are received by the receiver from different beacons (e.g. terrestrial transmitters and/or satellites). If position information like the transmission time and reception time of a positioning signal from a beacon are known, then the difference between those times multiplied by speed of light would provide an estimate of the distance traveled by that positioning signal from that beacon to the receiver. Different estimated distances corresponding to different positioning signals from different beacons can be used along with position information like the locations of those beacons to estimate the position of the receiver. Positioning systems and methods that estimate a position of a receiver based on positioning signals from beacons (e.g. transmitters, and/or satellites) are described in co-assigned U.S. Pat. No. 8,130,141, issued Mar. 6, 2012, and U.S. Patent Application Publication No. US 2012/0182180, published Jul. 19, 2012.

### RELATED APPLICATIONS

This application relates to the following related application(s): U.S. Pat. Appl. No. 62/250,477, filed 3 Nov. 2015, entitled USING POSITIONING SIGNALS FROM TRANSMITTERS OF ONE NETWORK TO ESTIMATE POSITIONS OF MOBILE DEVICES OF OTHER NETWORKS. The content of each of the related application(s) is hereby incorporated by reference herein in its entirety.

1. A method for using positioning signals transmitted from one terrestrial transmitter network in support of estimating positions of receivers of other terrestrial transmitter networks, the method comprising:
receiving, at a first receiver authorized to transmit signals through a first terrestrial transmitter network, assistance data associated with terrestrial transmitters of a second terrestrial transmitter network through which the first receiver is not authorized to transmit signals;
receiving, at the first receiver, one or more positioning signals transmitted from one or more transmitters of the second network; and
estimating a position of the first receiver using the positioning signals and the assistance data.

2. The method of claim 1, wherein the first network is a first wireless cellular network operated by a first network operator and the second network is a second wireless cellular network operated by a second network operator.

3. The method of claim 1, wherein the positioning signals are Long Term Evolution (LTE) Positioning Reference Signals (PRS), and the assistance data specifies an identifier, timing information, and position coordinates for at least one of the transmitters.

4. The method of claim 1, wherein the assistance data is received from a server operated by the first network operator.

5. The method of claim 1, wherein the assistance data is received from a server operated by the second network operator.

6. The method of claim 1, wherein the assistance data is received from a server operated by a third network operator through which the first receiver is not authorized to transmit signals.

7. The method of claim 1, wherein a part of the assistance data is received from a server operated by the first network operator, and another part of the assistance data is received from a server operated by the second network operator.

8. The method of claim 1, wherein a part of the assistance data is received from a server operated by the first network operator, and another part of the assistance data is received from a server operated by a third network operator through which the first receiver is not authorized to transmit signals.

9. The method of claim 1, wherein a part of the assistance data is received from a server operated by the second network operator, and another part of the assistance data is received from a server operated by a third network operator through which the first receiver is not authorized to transmit signals.

10. The method of claim 1, the method further comprising:
receiving the assistance data at a second receiver, wherein the second receiver is authorized to transmit signals through the second network, but not authorized to transmit signals through the first network;
receiving the positioning signals at the second receiver; and
estimating a position of the second receiver using the positioning signals and the assistance data.

11. The method of claim 1, wherein the first network estimates the position of the first receiver.

12. The method of claim 10, wherein the position of the first receiver is estimated by the first network, and wherein the position of the second receiver is estimated by the second network.

13. The method of claim 1, wherein the first receiver receives the positioning signals transmitted from the transmitters of the second network when the first receiver is in a first coverage area, the method further comprising:
receiving, at the first receiver, other assistance data associated with transmitters of the first network when the receiver is in a second coverage area;
receiving, at the first receiver, other positioning signals transmitted from the transmitters of the first network when the receiver is in the second coverage area; and
estimating another position of the first receiver using the other positioning signals and the other assistance data.

14. The method of claim 13, the method further comprising:
receiving the assistance data at a second receiver when the second receiver is in the first coverage area, wherein the second receiver is authorized to transmit signals through the second network, but not authorized to transmit signals through the first network;
receiving the positioning signals at the second receiver when the second receiver is in the first coverage area;
estimating a position of the second receiver using the positioning signals and the assistance data;
receiving the other assistance data at the second receiver when the second receiver is in the second coverage area;
receiving other positioning signals at the second receiver when the second receiver is in the second coverage area; and
estimating another position of the second receiver using the other positioning signals and the other assistance data.

15. The method of claim 1, wherein the first receiver receives the positioning signals transmitted from the transmitters of the second network when the first receiver is in a first coverage area during a first time period, the method further comprising:
receiving, at the first receiver, other assistance data associated with the transmitters of the first network when the first receiver is in the first coverage area during a second time period;
receiving, at the first receiver, other positioning signals transmitted from the transmitters of the first network when the receiver is in the first coverage area during the second time period; and
estimating another position of the first receiver using the other positioning signals and the other assistance data.

16. The method of claim 15, the method further comprising:
receiving the positioning signals at a second receiver when the second receiver is in the first coverage area during the first time period, wherein the second receiver is authorized to transmit signals through the second network, but not authorized to transmit signals through the first network;
receiving the assistance data at the second receiver when the second receiver is in the first coverage area during the first time period;
estimating a position of the second receiver using the positioning signals and the assistance data;
receiving the other assistance data at the second receiver when the second receiver is in the first coverage area during the second time period;
receiving the other positioning signals at the second receiver when the second receiver is in the first coverage area during the second time period; and
estimating another position of the second receiver using the other positioning signals and the other assistance data.

17. The method of claim 1, the method further comprising:
receiving, at the first receiver, other assistance data associated with terrestrial transmitters of the first network; and
receiving, at the first receiver, other positioning signals transmitted from the transmitters of the first network,
wherein the position of the first receiver is estimated using the other positioning signals and the other assistance data.

18. The method of claim 1, wherein the first network and the second network are synchronized with each other.

19. A positioning system for transmitting positioning signals in support of estimating positions of receivers, the system comprising:
a first network of transmitters operated by a first network operator across a first set of coverage areas, the first network being operable to receive information from a first receiver and provide that information to a remote source;
a second network of transmitters operated by a second network operator across a second set of coverage areas, the second network not being operable to receive information from the first receiver and provide that information to the remote source;
a server of the first network, the second network, or a third network, the server being operable to provide assistance data associated with the second network of transmitters to the first receiver; and
a location computation module operable to estimate the position of the first receiver using positioning signals transmitted from the second network and the assistance data associated with the second network.

20. One or more non-transitory machine-readable media embodying program instructions that, when executed by one or more machines, cause the one or more machines to perform the method of claim 1.
